(19) United States
(12) Patent Application Publication
(10) Pub. No.: US 2007/0076135 A1
(43) Pub. Date: Apr. 5, 2007

(54) Light modulation element and image display device

(75) Inventors: Makoto Gomyou, Kanagawa (JP); Haruo Harada, Kanagawa (JP); Yasunori Okano, Kanagawa (JP); Taijyu Gan, Kanagawa (JP); Hiroshi Arisawa, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/448,064

(22) Filed: Jun. 7, 2006

(30) Foreign Application Priority Data
Oct. 5, 2005 (JP) 2005-291894

(51) Int. Cl. G02F 1/135

(52) U.S. Cl. 349/25

(57) ABSTRACT

The present invention provides a light modulation element in which a visible image is written by simultaneously conducting irradiation of the light modulation element with exposure light according to image information which corresponds to the visible image and application of a voltage, having: a pair of electrodes to which the voltage is applied; a photoconductive layer which, when the light modulation element has been irradiated with the exposure light, shows an electric characteristic distribution corresponding to the intensity distribution of the exposure light; a liquid crystal layer to which a partial voltage derived from the voltage applied to the pair of electrodes and having a distribution corresponding to the electric characteristic distribution of the photoconductive layer is applied to record a visible image having an optical characteristic distribution corresponding to the distribution of the partial voltage; and a light shielding layer disposed between the photoconductive layer and the liquid crystal layer, wherein the photoconductive layer, the liquid crystal layer and the light shielding layer are disposed between the electrodes, and the light shielding layer contains a resin including partially saponified polyvinyl alcohol; and an image display device including the same.

### CROSS-REFERENCE TO RELATED APPLICATION

This application claims priority under 35 U.S.C. 119 from Japanese Patent Application No. 2005-291894, the disclosure of which is incorporated by reference herein.

### TECHNICAL FIELD

The invention relates to a light modulation element having a photoconductive layer, a light shielding layer and a liquid crystal layer which are laminated, and to an image display device including the same.

### RELATED ART

Light modulation elements that make use of the electro-optic effect, the magneto-optic effect or the acousto-optic effect are conventionally known. However, since there are limits to these elements with respect to high precision and high speed in the modulation, an element which optically conducts light modulation is gathering attention. As an element that optically conducts light modulation, an element having a combination of a photoconductive layer and a liquid crystal layer and an element including a mixture of a ferroelectric liquid crystal and a photochromic compound have been proposed.

FIG. 5 is a sectional view of a conventional light modulation element having a combination of a photoconductive layer and a liquid crystal layer. The light modulation element shown in FIG. 5 has substrates 20 and 26 such as films, a pair of electrodes 21 and 25 respectively formed on the substrates 20 and 26, and, between the electrodes 21 and 25, a liquid crystal layer 22, a photoconductive layer 24 and a light shielding layer 23 disposed between the liquid crystal layer 22 and the photoconductive layer 24.

When a voltage is applied between the electrodes 21 and 25 of the light modulation element, the respective partial voltages are applied to the liquid crystal layer 22, the light shielding layer 23 and the photoconductive layer 24. When writing light (exposure light) 28 is image-wise irradiated on the element, and reaches the photoconductive layer 24 on which the partial voltage is being applied, the distribution of the resistance of the photoconductive layer 24 is altered according to the irradiated writing light 28. As a result, the partial voltage applied to portions of the liquid crystal layer 22 which correspond to portions of the element which have been irradiated with the writing light 28 becomes higher. The variation of the distribution of the voltage applied to the liquid crystal layer 22 causes the orientation of the liquid crystal to change. Thus, information corresponding to the writing light 28 is displayed or recorded in the liquid crystal layer 22. Furthermore, the variation of the distribution of the orientation produces distributions of optical characteristics such as transmittance, absorptivity and reflectance in the light modulation element, enabling the element to function as a modulation element.

In order to read the optical characteristic distribution in the liquid crystal layer 22 by using light, reading light 27 is allowed to enter the element and to reach the liquid crystal layer 22. However, if the reading light 27 undesirably passes through the liquid crystal layer 22 and reaches the photoconductive layer 24, the optical characteristic distribution of the liquid crystal layer 22 may change. Thus, to inhibit the reading light 27 from reaching the photoconductive layer 24, the light shielding layer 23 is disposed between the liquid crystal layer 22 and the photoconductive layer 24.

The light shielding layer 23 generally includes a resinous coating material in which a pigment or a dye is dispersed in a hydrophobic resin such as an acrylic resin. However, when such a light shielding layer 23 is in direct contact with the liquid crystal layer 22, the liquid crystal acts as a solvent to dissolve the light shielding layer 23, or components of the pigment or dye or additives such as a surfactant or a hardener in the light shielding layer seep into the liquid crystal layer 22 in some cases. When such components seep into the liquid crystal layer, the resistance value of the liquid crystal layer 22 changes, upsetting the balance among the partial voltages which are obtained by distributing the voltage applied to the light modulation element and which are applied to the respective layers. Therefore, the behavior of the liquid crystal layer 22 becomes unstable.

Accordingly, there is a need for a light modulation element which can prevent components of the light shielding layer from seeping into the liquid crystal layer and destabilization of the behavior of the liquid crystal layer, and which therefore has excellent stability. In addition, there is a need for an image display device including the light modulation element.

### SUMMARY

A first aspect of the invention provides a light modulation element in which a visible image is written by simultaneously conducting irradiation of the light modulation element with exposure light according to image information which corresponds to the visible image and application of a voltage, having: a pair of electrodes to which the voltage is applied; a photoconductive layer which, when the light modulation element has been irradiated with the exposure light, shows an electric characteristic distribution corresponding to an intensity distribution of the exposure light; a liquid crystal layer to which a partial voltage derived from the voltage applied to the pair of electrodes and having a distribution corresponding to the electric characteristic distribution of the photoconductive layer is applied to record a visible image having an optical characteristic distribution corresponding to the distribution of the partial voltage; and a light shielding layer disposed between the photoconductive layer and the liquid crystal layer, wherein the photoconductive layer, the liquid crystal layer and the light shielding layer are disposed between the electrodes, and the light shielding layer contains a resin including partially saponified polyvinyl alcohol.

A second aspect of the invention provides an image display device, having: a light modulation unit including a light modulation element in which a visible image is written by simultaneously conducting irradiation of the light modulation element with exposure light according to image information which corresponds to the visible image and application of a voltage; and a writing unit for writing the visible image in the light modulation unit, wherein: the light modulation element has a pair of electrodes to which the voltage is applied, a photoconductive layer which, when the light modulation element has been irradiated with the exposure light, shows an electric characteristic distribution corresponding to an intensity distribution of the exposure light, a liquid crystal layer to which a partial voltage derived from the voltage applied to the pair of electrodes and having a distribution corresponding to the electric characteristic distribution of the photoconductive layer is applied to record a visible image having an optical characteristic distribution corresponding to the distribution of the partial voltage, and a light shielding layer disposed between the photoconductive layer and the liquid crystal layer, wherein the photoconductive layer, the liquid crystal layer and the light shielding layer are disposed between the electrodes, and the light shielding layer contains a resin including partially saponified polyvinyl alcohol; and the writing unit has a voltage application sub-unit which applies the voltage to the pair of electrodes of the light modulation element, a light irradiation sub-unit which irradiates the light modulation element with the exposure light, and a controller which controls the voltage application sub-unit and the light irradiation sub-unit.

### BRIEF DESCRIPTION OF DRAWINGS

Preferred embodiments of the invention will be described in detail based on the following figures, wherein

FIG. 1 is a sectional view showing an embodiment of a light modulation element according to the invention;

FIG. 2 is a schematic diagram showing an embodiment of an image display device including light modulation elements according to the invention;

FIG. 3 is a schematic diagram showing another embodiment of an image display device including light modulation elements according to the invention;

FIG. 4 is a schematic diagram showing still another embodiment of an image display device including light modulation elements according to the invention; and

FIG. 5 is a sectional view of a conventional light modulation element having a combination of a photoconductive layer and a liquid crystal layer.

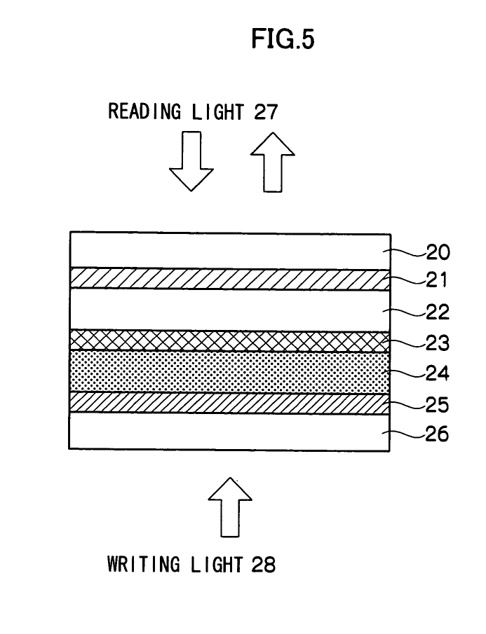

### DETAILED DESCRIPTION

The light modulation element of the invention is an element in which a visible image is written by simultaneously conducting irradiation of the light modulation element with exposure light according to image information which corresponds to the visible image and application of a voltage. The light modulation element has a pair of electrodes to which the voltage is applied; a photoconductive layer which, when the light modulation element has been irradiated with the exposure light, shows an electric characteristic distribution corresponding to an intensity distribution of the exposure light; a liquid crystal layer to which a partial voltage derived from the voltage applied to the pair of electrodes and having a distribution corresponding to the electric characteristic distribution of the photoconductive layer is applied to record a visible image having an optical characteristic distribution corresponding to the distribution of the partial voltage; and a light shielding layer disposed between the photoconductive layer and the liquid crystal layer. The photoconductive layer, the liquid crystal layer and the light shielding layer are disposed between the electrodes. In addition, the light shielding layer contains a resin including partially saponified polyvinyl alcohol.

When the light shielding layer of the aforementioned conventional light modulation element includes an acrylic resin, some components of the light shielding layer seep into the liquid crystal layer. This is because the acrylic resin, which is soluble in an organic solvent, is compatible with the liquid crystal. Alternatively, when the light shielding layer includes an aqueous resin that does not dissolve in the liquid crystal, the pigment of the light shielding layer is insufficiently dispersed therein. As a result, some pigment particles protrude from the surface of the light shielding layer which surface adjoins the liquid crystal layer and some components contained in the pigment particles directly seep from the pigment particles into the liquid crystal layer.

The invention has been made in view of the above circumstances. The inventors have found that use of partially saponified polyvinyl alcohol as the binder of the light shielding layer can suppress seepage of components from the light shielding layer and change of the resistance of the liquid crystal layer and, therefore, can stabilize the reflectance of the liquid crystal layer for a long period of time.

Specifically, the following has been found.

It is effective that polyvinyl alcohol, which is soluble in water but insoluble in liquid crystal, is contained in a light shielding layer. Here, conventionally known, completely saponified polyvinyl alcohol has a high degree of crystallinity and excellent capability of separating the components of the light shielding layer from liquid crystal. Therefore, in the case of a light modulation element having a light shielding layer, and a liquid crystal layer, and an isolating layer disposed therebetween, such polyvinyl alcohol can be suitably used in the isolating layer, as disclosed in JP-A No. 2003-5210. However, production of such a light modulation element requires an increased number of manufacturing processes. Moreover, the element is thick. Alternatively, when completely saponified polyvinyl alcohol is used as the binder of the light shielding layer, a pigment cannot be sufficiently dispersed therein. As a result, some pigment particles protrude from the surface of the light shielding layer and thereby impurities contained in the pigment particles inevitably seep into the liquid crystal layer, as aforementioned.

On the other hand, it has been found that a light shielding layer including partially saponified polyvinyl alcohol as the binder thereof is excellent in terms of the following points. That is, additives such as a pigment can be well dispersed in the light shielding layer and are not directly exposed on the surface of the light shielding layer, and impurities contained in the additives can be prevented from seeping into the liquid crystal layer, while good resistance of polyvinyl alcohol with respect to liquid crystal can be maintained.

Since partially saponified polyvinyl alcohol is included in the light shielding layer (used as the binder) of the light modulation element of the invention, the light shielding layer has both of seepage resistance and a well-dispersed state of additives such as a pigment.

Polyvinyl alcohol can be obtained by substituting acetyl groups of polyvinyl acetate with hydroxyl groups and this synthesis reaction is called saponification. In the invention, the saponification degree of polyvinyl alcohol is the percentage of the number of the hydroxyl groups to the total number of the acetyl groups and the hydroxyl groups in the polyvinyl alcohol. The partially saponified polyvinyl alcohol in the invention has a saponification degree, or the percentage of the number of hydroxyl groups, with which acetyl groups of polyvinyl acetate serving as the raw material of polyvinyl alcohol have been substituted, to the number of all the acetyl groups which the polyvinyl acetate originally has, of less than 97%, and, in other words, has both of hydroxyl groups and acetyl groups as the side chains thereof. Details of the partially saponified polyvinyl alcohol will be described later.

Hereinafter, the light modulation element of the invention will be described, while referring to the drawings.

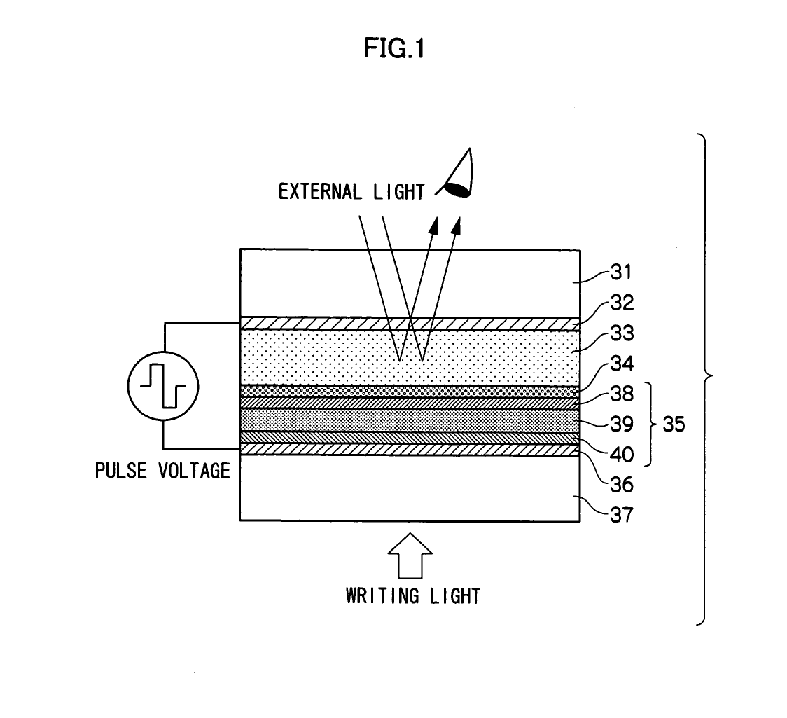

FIG. 1 is a sectional view showing an embodiment of a light modulation element of the invention. The light modulation element shown in FIG. 1 has transparent substrates 31 and 37 respectively having thereon transparent electrodes (electrodes) 32 and 36 made of ITO, and, between the electrodes 32 and 36, an organic photoconductor (OPC) layer 35, a liquid crystal layer 33, and a light shielding layer 34. The OPC layer 35 serves as a photoconductive layer whose resistance value decreases when the layer is irradiated with exposure light (writing light) having a predetermined wavelength. This variation of the resistance value of the OPC layer 35 causes change of a partial voltage which is derived from a voltage applied between the electrodes 32 and 36 and which is applied to the liquid crystal layer 33, resulting in change of the distribution of the orientation of the liquid crystal. Thus, information corresponding to the distribution of optical characteristics is recorded in the liquid crystal layer 33. The light shielding layer 34 is disposed between the OPC layer 35 and the liquid crystal layer 33 and absorbs light from an external light source and exposure light.

The transparent substrates 31 and 37 are made of an insulating material such as an inorganic sheet made of, for example, glass or silicon, or a film of polymer, including polyethylene terephthalate, polysulfone, polyethersulfone, polycarbonate or polyethylene naphthalate.

Thickness of each of the transparent substrates 31 and 37 is preferably in the range of about 0.01 to about 0.5 mm.

In this embodiment, the transparent electrodes 32 and 36 are made of ITO (indium tin oxide), as described. However, each of the transparent electrodes can be a transparent electric conductor other than ITO, for example, a thin film of metal (e.g., gold), oxide (e.g., SnO₂ or ZnO), or an electrically conductive polymer (e.g., polypyrrole). In the embodiment, the transparent electrodes 32 and 36 (a pair of electrodes) of the light modulation element are formed by sputtering the above substance on the respective transparent substrates 31 and 37. However, the production method of the electrodes is not limited to such a sputtering method, and, for example, a printing method, a CVD method or a deposition method can be used to form the electrodes.

As for the forms and a driving method of the transparent electrodes 32 and 36 in this embodiment, these electrodes are common electrodes in a display region, and are driven in accordance with a driving method described in JP-A Nos. 2003-140184 and 2000-111942. However, the driving method of the electrodes 32 and 36 may also be a segment driving method which uses, as one of the electrode 32 formed on the transparent substrate 31 and the electrode 36 formed on the transparent substrate 37, an electrode common to the pixels of an image to be displayed in the light modulation element and, as the other, a separate electrode for each of the pixels, a simple matrix driving method which uses primary electrodes serving as the electrode 32 and disposed in a stripe pattern, and secondary electrodes serving as the electrode 36 and disposed in a stripe pattern and orthogonal to the primary electrodes in the plan view of the element and, as regions corresponding to the respective pixels, positions at each of which one of the primary electrodes faces one of the secondary electrodes, or an active matrix driving method which uses, as one of the electrodes 32 and 36, an electrode common to the pixels of an image, and, as the other, a combination of scanning electrodes disposed in a stripe pattern, signal electrodes disposed in a stripe pattern and orthogonal to the scanning electrodes in the plan view of the element, and functional elements such as TFTs or MINs.

In the embodiment, the liquid crystal layer 33 has a polymer dispersed liquid crystal (PDLC) structure where chiral nematic liquid crystal (cholesteric liquid crystal) is dispersed in a gelatin binder. However, the structure of the liquid crystal layer in the invention is not limited to this, and the liquid crystal layer 33 may have a structure where cholesteric liquid crystal is put in cells defined by electrodes, the distance between which is fixed by a rib, or a structure including capsules of liquid crystal. Furthermore, the liquid crystal contained in the liquid crystal layer 33 is not limited to cholesteric liquid crystal, and can also be at least one of smectic A liquid crystal, nematic liquid crystal and discotic liquid crystal.

When liquid crystal having an image retention property, such as chiral nematic liquid crystal, surface-stabilized chiral smectic C liquid crystal, bi-stable twisted nematic liquid crystal or fine particle-dispersed liquid crystal, is used in the light modulation element in the invention, the light modulation element can be utilized in an optical recording medium, an image recording medium, or an image display device.

The light modulation element of the invention may also have, as an auxiliary member that aids variation of optical characteristics of the liquid crystal, at least one passive optical component such as a polarization plate, a phase difference plate or a reflection plate. Alternatively, the light modulation element may include a dichroic dye in the liquid crystal.

In general, the thickness of the liquid crystal layer 33 is preferably in the range of about 1 to about 50 μm.

The material of the liquid crystal layer (liquid crystal material) may be a known liquid crystal composition such as a composition including cyanobiphenyl, phenylcyclohexyl, phenyl benzoate, cyclohexyl benzoate, azomethine, azobenzene, pyrimidine, dioxane, cyclohexylcyclohexane, stilbene or tolane liquid crystal. As described above, the liquid crystal material may include at least one additive such as a dye, for example a dichroic dye, or fine particles. Such an additive or additives may be dispersed in a polymer matrix, gelated with a polymer, or micro-capsulated. Furthermore, the liquid crystal may be any one of a macro molecule, a middle molecule, a low molecule and a mixture thereof.

Examples of the photoconductive layer include (a) inorganic semiconductor layers made of amorphous silicon or a compound semiconductor such as ZnSe or CdS; (b) organic semiconductor layers made of anthracene or polyvinyl carbazole; and (c) so-called OPC layers made of a mixture or layered body of a charge-generating material that generates electric charges under light irradiation and a charge transport material which transports the electric charges under an electric field.

Examples of the charge-generating material include perylenes, phthalocyanines, bisazo compounds, diketopyrrolopyrrole, squaliliums, azleniums and thiapyrilium/polycarbonate. Examples of the charge transport material include trinitrofluorenes, polyvinyl carbazoles, oxadiazoles, pyrazolines, hydrazones, stilbenes, triphenylamines, triphenylmethanes and diamine compounds; and ionic conductive materials such as LiClO₄-added polyvinyl alcohol and polyethylene oxide. Furthermore, as a composite material of the charge-generating material and the charge transport material, a layered body, a mixture or microcapsules can be used.

In the configuration shown in FIG. 1, the photoconductive layer is the organic photoconductor (OPC) layer 35, which includes two charge-generating layers (CGL) 38 and 40 and a charge transport layer (CTL) 39.

The thickness of the photoconductor layer is in the range of about 1 to about 100 μm, and the ratio of the resistance of the photoconductor layer which is being irradiated with the exposure light to that of the photoconductor layer which is not being irradiated with the exposure light is preferably high.

The light shielding layer 34 is made of a material which absorbs reading light emitted by an external light source and at least part of exposure light which has passed through the OPC layer 35 and which has a high electric resistance. The optical density necessary for the light shielding layer 34 cannot be clearly defined, since the optical density depends on the sensitivity of the OPC layer 35 and the intensity of the reading light. However, the optical density is preferably 1 or more and more preferably 2 or more in the wavelength region of light to be shielded. Furthermore, in order to prevent current inside of the light shielding layer from deteriorating resolution, the electric resistance (i.e., volume resistivity) of the light shielding layer 34 is preferably at least 10⁸ Ωcm. In addition, the electrostatic capacitance of the light shielding layer 34 is preferably as large as possible in order to increase the degree of change of the partial voltage applied to the liquid crystal layer 33. Therefore, the light shielding layer 34 preferably has a high dielectric constant and is preferably thin.

When irradiation of the OPC layer 35 with exposure light corresponding to image information, and application of a rectangular voltage to the transparent electrodes 32 and 37 are simultaneously conducted, an image pattern can be recorded in the liquid crystal layer 33, which has an information-storing property. As shown in FIG. 1, the image pattern can be made visible, when external light gets in the element and is reflected by the liquid crystal layer 33. In this case, the light modulation element of the invention can be utilized in a reflective image recording medium.

In order to inhibit light which has entered the element through the substrate 37 from passing through the OPC layer and, therefore, degrading visibility in this case, the wavelength region of light which can be absorbed by the light shielding layer 34 preferably includes not only the wavelength region of reading light used to read the image pattern recorded in the liquid crystal layer 33 but also the whole wavelength region of visible light (400 to 800 nm). The optical density of the light shielding layer 34 is preferably at least 1 and more preferably at least 2, as described above. Since light having wavelengths within the region of 400 to 700 nm has a particularly high luminosity, increasing the optical density in this wavelength region can effectively inhibit visibility from deteriorating.

When the light modulation element is used in an image recording medium, the reading light to be shielded by the light modulation element is a part or the whole of external light (sunlight and room light) having wavelengths within the wavelength region of visible light, which observers can perceive. If the OPC layer 35 is sensitive to light within a wavelength region other than that of visible light, such as UV light or IR light, such light may cause so-called fog, lead to recording of unnecessary information in the liquid crystal layer 33, and adversely affect preservation of intentionally recorded information.

Accordingly, the wavelength region of light which can be absorbed by the light shielding layer 34 preferably includes the whole wavelength region of light to which the OPC layer 35 is sensitive and which can be used as exposure light, if necessary.

The light shielding layer 34 can contain a resinous coloring material such as a material where at least one pigment is dispersed in at least one resin or a material where at least one dye is dissolved in at least one resin. In the invention, the at least one resin (binder) includes the aforementioned partially saponified polyvinyl alcohol. The partially saponified polyvinyl alcohol used in the invention preferably has a saponification degree of less than about 97 mole percent, and more preferably has a saponification degree of about 70 to about 90 mole percent.

When the saponification degree is about 97 mole percent or more (complete saponification), additives such as a pigment cannot be well dispersed in such polyvinyl alcohol.

Furthermore, the polymerization degree of the partially saponified polyvinyl alcohol is preferably in the range of about 300 to about 2,000 and more preferably in the range of about 500 to about 1,300. When the polymerization degree is less than about 300, such a light shielding layer has insufficient strength, and, therefore, a decreased ability of preventing components of the light shielding layer such as a pigment from seeping into the liquid crystal layer. On the other hand, when the polymerization degree exceeds about 2000, a liquid for forming a light shielding layer containing such polyvinyl alcohol has an extremely high viscosity and thereby is difficult to handle. In addition, since a pigment cannot be well dispersed in such polyvinyl alcohol, the components of the pigment seep into the liquid crystal, which degrades the performance of the light modulation element.

The saponification degree and the polymerization degree can be obtained according to JIS K6726 (1994), which is incorporated by reference herein.

It is necessary that the light shielding layer in the invention contains the partially saponified polyvinyl alcohol as a binder thereof. The light shielding layer may contain only the partially saponified polyvinyl alcohol as the binder or may further contain any other resin.

The resin(s) which is other than the partially saponified polyvinyl alcohol and can be used as one of the binders of the light shielding layer is preferably an aqueous resin. Specifically, the aqueous resin has at least one hydrophilic group such as a carboxyl group, a sulfonic group, an amino group, a hydroxyl group, a polyethylene glycol skeleton, an amide group or a methylolamine group. Examples thereof include methyl cellulose, hydroxyethyl cellulose, polyethylene oxide, acrylic amide, an alkyd resin, an acrylic resin, a melamine resin, an epoxy resin, a urethane resin and a polyester resin. The light shielding layer may contain at least one cross-linking agent such as glyoxal or polyisocyanate in combination with the aqueous resin. However, to inhibit impurities of the light shielding layer from seeping into the liquid crystal, the cross-linking agent and the resin are preferably non-ionic.

When the light shielding layer further contains at least one resin other than the partially saponified polyvinyl alcohol, the amount thereof is preferably in the range of about 1 to about 90 parts by mass relative to 100 parts by mass of the partially saponified polyvinyl alcohol.

The pigment(s) can be at least one of inorganic pigments such as carbon black and chromium oxide and organic pigments such as azo pigments and phthalocyanine pigments. The dye(s) can be at least one of nitroso dyes, nitro dyes, azo dyes, stilbenazo dyes, diphenylmethane dyes, triphenylmethane dyes, xanthene dyes, acrydine dyes, quinoline dyes, polymethine dyes, thiazole dyes, indophenol dyes, azine dyes, oxazine dyes, thiazine dyes, sulphurized dyes, aminoketone dyes, anthraquinone dyes and indigoide dyes.

The mass ratio of the pigment(s) to the resin(s) in the light shielding layer in the invention is preferably in the range of 20/80 to 40/60 and more preferably in the range of 25/75 to 35/65.

The light shielding layer can be obtained by preparing an aqueous ink including the pigment(s) and the resin(s) and coating the aqueous ink by a coating method such as a roll coating method, a spin coating method, a bar coating method, a dip coating method, a die coating method, a gravure printing method, a flexo printing method or a screen printing method.

The primary solvent of the aqueous ink is water. The aqueous ink may further contain at least one additive such as a deforming agent, a thickener or a filler. In order to obtain a high electric resistance, it is necessary that water, which is the solvent of the aqueous ink, is removed from the resultant coating by heating and drying the coating.

The aqueous ink where the partially saponified polyvinyl alcohol is dissolved in water has the following advantages. The ink has a relatively high viscosity. Moreover, it is easy to prepare an aqueous ink having a viscosity which is so controlled as to be suitable for coating. The thickness of the thus prepared light shielding layer is preferably in the range of about 0.5 to about 3.0 μm and more preferably in the range of about 0.7 to about 2.0 μm.

The dispersion state of the pigment(s) in the light shielding layer in the invention is preferably such that, when the surface of the light shielding layer obtained by coating and drying is observed with a microscope (magnification of substantially 1000 times), there is no pigment particle exposed on the surface without being covered with other component.

In the next place, an image display device having the light modulation elements of the invention will be briefly described.

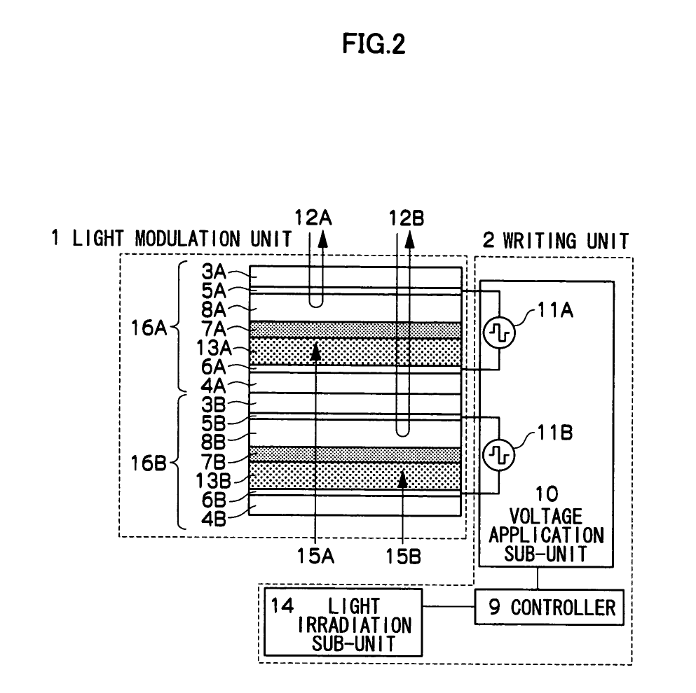

FIG. 2 is a schematic diagram showing an embodiment of an image display device having light modulation elements of the invention. As shown in FIG. 2, the image display device has a light modulation unit 1 including two light modulation elements 16A and 16B. The light modulation element 16A has substrates 3A and 4A on which transparent electrodes 5A and 6A are formed, respectively. The light modulation element 16A further has a liquid crystal layer 8A that reflects reading light 12A, a light shielding layer 7A and a photoconductive layer 13A, and these layers are laminated between the transparent electrodes 5A and 6A. The light modulation element 16B has substrates 3B and 4B on which transparent electrodes 5B and 6B are formed, respectively. The light modulation element 16B further has a liquid crystal layer 8B that reflects reading light 12B, a light shielding layer 7B and a photoconductive layer 13B, and these layers are laminated between the transparent electrodes 5B and 6B. The light modulation elements 16A and 16B may have one common substrate in place of the substrates 4A and 3B.

The image display device further has a writing unit 2. The wiring unit 2 includes a voltage application sub-unit 10 that impresses a bias voltage 11A between the transparent electrodes 5A and 6A of the light modulation element 16A and a bias voltage 11B between the transparent electrodes 5B and 6B of the light modulation element 16B; a light irradiation sub-unit 14 that irradiates writing light (exposure light) 15A, which reaches the photoconductive layer 13A of the light modulation element 16A, and writing light (exposure light) 151B, which reaches the photoconductive layer 13B of the light modulation element 16B; and a controller 9 that controls and synchronizes the voltage application sub-unit 10 and the light irradiation sub-unit 14.

The basic structure of each of the two light modulation elements 16A and 16B of the image display device is the same as that of the light modulation element shown in FIG. 1. However, the material(s) of the photoconductive layer 13A is so selected that the material absorbs the writing light 15A but transmits reading light 12B. Moreover, the material(s) of the photoconductive layer 13B is so selected that the material absorbs the writing light 15B but transmits the writing light 15A.

Given that each of the writing light 15A and the reading light 12A is blue light, and each of the writing light 15B and the reading light 12B is red light, and the light shielding layer 7A has red (or yellow) color, which absorbs the reading light 12A and the writing light 15A, and the light shielding layer 7B has blue (or cyan) color, which absorbs the reading light 12B and the writing light 15B in such a structure, a color image can be written and displayed in the device without mingling the exposure light and the reading light by irradiating color address light.

The image display device shown in FIG. 2 is driven as follows. The value of the bias voltage 11A is selected in consideration of the operational threshold voltage of the liquid crystal layer 8A, and the intensity of the writing light 15A is selected in consideration of the light sensitivity of the photoconductive layer 13A. In addition, the value of the bias voltage 11B is selected in consideration of the operational threshold voltage of the liquid crystal layer 8B, and the intensity of the writing light 15B is selected in consideration of the light sensitivity of the photoconductive layer 13B. The voltage application sub-unit 10 of the writing unit 2 impresses the bias voltage 11A between the transparent electrodes 5A and 6A and the bias voltage 11B between the transparent electrodes 5B and 6B. At the same time, the light irradiation sub-unit 14 irradiates the optical modulation unit 1 with the writing light 15A and the writing light 15B. Thereby, the optical states of the liquid crystal layers 8A and 8B, or more specifically, the reflection state of the liquid crystal layer 8A with respect to the reading light 12A and the reflection state of the liquid crystal layer 8B with respect to the reading light 12B are changed. The controller 9 controls the timing for application of the bias voltage 11A and that for irradiation of the writing light 15A so that these timings at least partially overlap with each other to enable simultaneous applications of bias voltage 11A which has reached a desired voltage value and writing light 15A whose intensity has reached a desired level to the optical modulation element 16A. A combination of the desired voltage and the desired (intensity) level is so set as to enable actual driving of the light modulation element 16A, which is a light address-type light modulation element. The controller 9 also controls the timing for application of the bias voltage 11B and that for irradiation of the writing light 15B so that these timings at least partially overlap with each other to enable simultaneous applications of bias voltage 11B which has reached a desired voltage value and writing light 15B whose intensity has reached a desired level to the optical modulation element 16B. A combination of the desired voltage and the desired (intensity) level is so set as to enable actual driving of the light modulation element 16B, which is a light address-type light modulation element.

The writing light 15A and the wiring light 15B, which correspond to the respective color images, get in the light modulation unit 1 of the image display device shown in FIG. 2 through the substrate 4B serving as the back surface of the light modulation unit 1. The photoconductive layer 13A of the light modulation element 16A absorbs a light component having a specific wavelength region and the photoconductive layer 13B of the light modulation element 16B absorbs a light component having another specific wavelength region from incident light, and the remaining light component, which has wavelength regions other than those specific wavelength regions, passes through the light modulation unit 1. When the photoconductive layer 13A has absorbed blue color (B color), the photoconductive layer 13A has a decreased electric resistance. However, green color (G color) and red color (R color), which are transmitted by the photoconductive layer 13A, do not alter the resistance value of the photoconductive layer 13A. On the other hand, when the photoconductive layer 13B has absorbed R color, the photoconductive layer 13B has a decreased electric resistance. However, B color and G color, which are transmitted by the photoconductive layer 13B, do not alter the resistance value of the photoconductive layer 13B.

As the resistance values of the photoconductive layers 13A and 13B decrease by respectively irradiating these layers with the writing light 15A and the writing light 15B, the values of the partial voltages respectively applied to the liquid crystal layers 8A and 8B increase, which raises the reflectance of each of the liquid crystal layers 8A and 8B with respect to the corresponding reading light within the reflection wavelength region. Specifically, external light enters the light modulation unit 1 through the substrate 3A serving as the front surface of the optical modulation unit 1, and the blue (B) component of the external light, or the reading light 12A, is reflected by portions of the liquid crystal layer 8A of the light modulation element 16A, reflectance of which portions with respect to blue light has increased by irradiating the corresponding portions of the photoconductive layer 13A with blue writing light 15A, and passes through the substrate 3A again to display an image of blue (B) color in the portions. The other portions of the liquid crystal layer 8A, reflectance of which portions with respect to blue light has not changed because of non-irradiation of the corresponding portions of the photoconductive layer 13A with blue writing light 15A, transmit the reading light 12A, and the light shielding layer 7A absorbs this reading light 12A. Accordingly, an image of blue color is not displayed there. Furthermore, the red (R) component of the external light, or the reading light 12B, passes through the light modulation element 16A, is reflected by portions of the liquid crystal layer 8B of the light modulation element 16B, reflectance of which portions with respect to red light has increased by irradiating the corresponding portions of the photoconductive layer 13B with red writing light 15B, and passes through the light modulation element 16A again to display an image of red (R) color in the portions. The other portions of the liquid crystal layer 8B, reflectance of which portions with respect to red light has not increased because of non-irradiation of the corresponding portions of the photoconductive layer 13B with red writing light 15B, transmit the reading light 12B, and the light shielding layer 7B absorbs this reading light 12B. Accordingly, an image of red color is not displayed there.

The light modulation unit 1 is irradiated with the writing light 15A and the writing light 15B, which correspond to the respective images to be displayed, from the back surface side to write an image, and the image is read from the front surface side by allowing the reading light 12A and the reading light 12B to enter the light modulation unit 1.

The light irradiation sub-unit 14 is any device that can emit writing light 15A and writing light 15B each having a desired intensity on the light modulation unit 1, and may be a self-emitting element such as a laser beam scanning device, an LED array, a CRT display device, a plasma display device or an EL display device; or a liquid crystal projector or a DLP projector each obtained by combining a light control element such as a liquid crystal shutter and a light source such as a fluorescent lamp, a xenon lamp, a halogen lamp, a mercury lamp or an LED lamp.

Colors used in the liquid crystal layers 8A and 8B are not restricted to blue color and red color. In addition, the combination and the arrangement of the layers of each light modulation element are not restricted to those of this embodiment.

The image display device of this embodiment has two light modulation elements, but may have only one element or at least three elements.

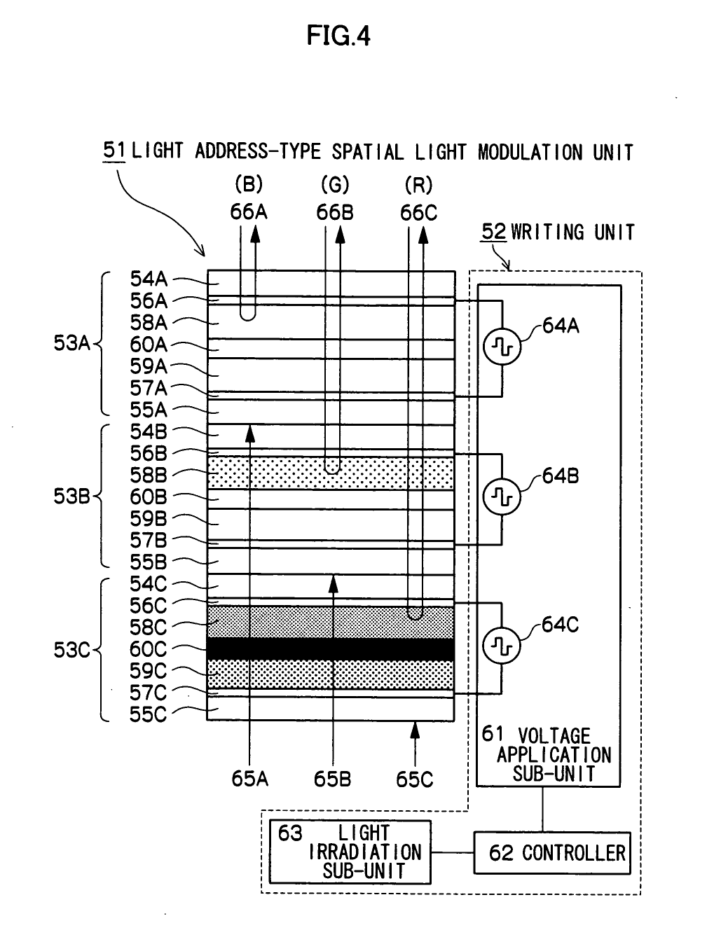

FIG. 4 is a schematic diagram showing another embodiment of the image display device that includes the light modulation elements of the invention.

In FIG. 4, the image display device has a light modulation unit 51 and a writing unit 52. The light modulation unit 51 has a structure where three light modulation elements 53A, 53B and 53C that modulate light, or different color (B, G and R) components of reading light, are layered in that order. The light modulation element 53A has substrates 54A and 55A on which electrodes 56A and 57A are formed, respectively. The light modulation element 53A further has a cholesteric (chiral nematic) liquid crystal layer 58A that selectively reflects blue (B) light, a yellow (Y) light shielding layer 60A that absorbs blue (B) light and a yellow (Y) photoconductive layer 59A that absorbs blue (B) light, and these layers are laminated between the electrodes 56A and 57A in that order. In other words, the liquid crystal layer 58A is the nearest to the electrode 56A of these layers.

Furthermore, the light modulation element 53B has substrates 54B and 55B on which electrodes 56B and 57B are formed, respectively. The light modulation element 53B further has a cholesteric (chiral nematic) liquid crystal layer 58B that selectively reflects green (G) light, a magenta (M) light shielding layer 60B that absorbs green (G) light and a magenta (M) photoconductive layer 59B that absorbs green (G) light, and these layers are laminated between the electrodes 56B and 57B in that order. In other words, the liquid crystal layer 58B is the nearest to the electrode 56B of these layers. Moreover, the substrate 54B is adjacent to the substrate 55A of the light modulation element 53A.

In addition, the light modulation element 53C has substrates 54C and 55C on which electrodes 56C and 57C are formed, respectively. The light modulation element 53C further has a cholesteric (chiral nematic) liquid crystal layer 58C that selectively reflects red (R) light, a cyan (C) light shielding layer 60C that absorbs red (R) light and a cyan (C) photoconductive layer 59C that absorbs red (R) light, and these layers are laminated between the electrodes 56C and 57C in that order. In other words, the liquid crystal layer 58C is the nearest to the electrode 56C of these layers. Moreover, the substrate 54C is adjacent to the substrate 55B of the light modulation element 53B and the substrate 55A is adjacent to the substrate 54B of the light modulation element 53B. Reading light 66 (66A, 66B and 66C) enters the light modulation unit 51 through the substrate 54A serving as the front surface of the unit 51 and writing light 65 (65A, 65B and 65C) enters the light modulation unit 51 through the substrate 55C serving as the back surface of the unit 51.

The light modulation unit 51, which is a light address-type spatial light modulation element, is electrically connected to the writing unit 52, and, thereby, enables writing and reading of an image. The writing unit 52 includes a voltage application sub-unit 61 that impresses a bias voltage 64A between the electrodes 56A and 57A of the light modulation element 53A, a bias voltage 64B between the electrodes 56B and 57B of the light modulation element 53B, and a bias voltage 64C between the electrodes 56C and 57C of the light modulation element 53C; a light irradiation sub-unit 53 that irradiates modulated writing light 65 (65A, 65B, and 65C) on the light modulation unit 51; and a controller 62 that controls the voltage application sub-unit 61 and the light irradiation sub-unit 63.

According to the above configuration, writing light 65A enters the light modulation unit 51 through the substrate 55C and reaches the photoconductive layer 59A of the light modulation element 53A without being absorbed by the light modulation elements 53B and 53C, and is absorbed by the photoconductive layer 59A and the light shielding layer 60A, and thereby inhibited from leaking therefrom and undesirably getting in the liquid crystal layer 58A. Furthermore, writing light 65B enters the light modulation unit 51 through the substrate 55C and reaches the photoconductive layer 59B of the light modulation element 53B without being absorbed by the light modulation element 53C, and is absorbed by the photoconductive layer 59B and the light shielding layer 60B, and thereby inhibited from leaking therefrom and undesirably getting in the liquid crystal layer 58B. Moreover, writing light 65C enters the light modulation unit 51 through the substrate 55C and reaches the photoconductive layer 59C of the light modulation element 53C, and is absorbed by the photoconductive layer 59C and the light shielding layer 60C, and thereby inhibited from leaking therefrom and undesirably getting in the liquid crystal layer 58C.

On the other hand, reading light 66C enters the light modulation unit 51 through the substrate 54A, reaches the liquid crystal layer 58C of the light modulation element 53C without being absorbed by the light modulation elements 53A and 53B, and, when the reading light 66C has passed through the liquid crystal layer 58C, is absorbed by the light shielding layer 60C and, therefore, inhibited from leaking therefrom and undesirably getting in the photoconductive layer 59C. Furthermore, reading light 66B enters the light modulation unit 51 through the substrate 54A, reaches the liquid crystal layer 58B of the light modulation element 53B without being absorbed by the light modulation element 53A, and, when the reading light 66B has passed through the liquid crystal layer 58B, is absorbed by the light shielding layer 60B and, therefore, inhibited from leaking therefrom and undesirably getting in the photoconductive layer 59B. Moreover, reading light 66A enters the light modulation unit 51 through the substrate 54A, reaches the liquid crystal layer 58A of the light modulation element 53A, and, when the reading light 66A has passed through the liquid crystal layer 58A, is absorbed by the light shielding layer 60A and, therefore, inhibited from leaking therefrom and undesirably getting in the photoconductive layer 59A.

Thus, even a device having a structure where three light modulation elements are layered can provide a stabilized behavior of each liquid crystal layer, if the device includes light shielding layers which have the aforementioned configuration and characteristics.

Each of the light modulation elements used in the aforementioned embodiments has one liquid crystal layer between the electrodes. However, the light modulation element may have plural liquid crystal layers.

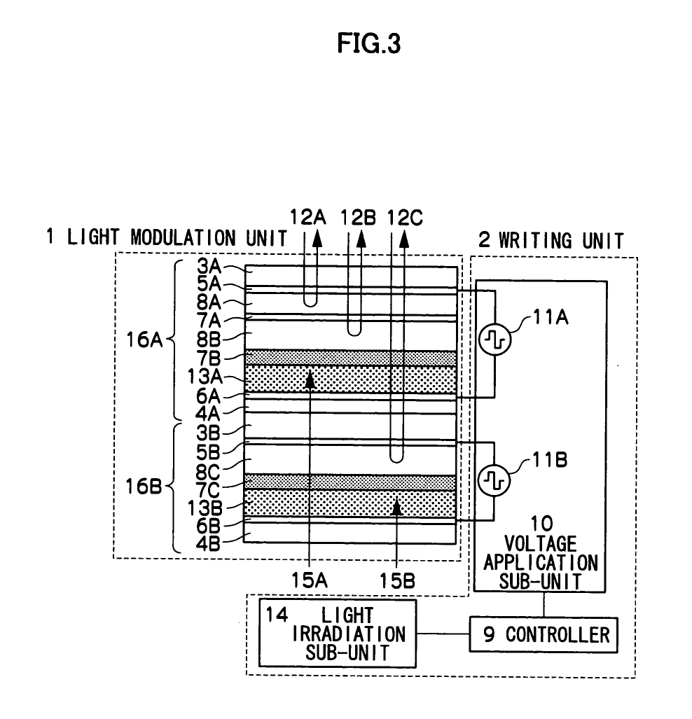

FIG. 3 shows still another embodiment of the image display device including the light modulation elements of the invention. The image display device has a light modulation unit 1 and a writing unit 2. The light modulation unit 1 has a combination of a light modulation element 16A which includes two liquid crystal layers 8A and 8B, and a light modulation element 16B which includes one liquid crystal layer 8C.

The light modulation element 16A has substrates 3A and 4A on which transparent electrodes 5A and 6A are formed, respectively. The light modulation element 16A further has the liquid crystal layers 8A and 8B, which respectively reflect reading light 12A and reading light 12B, light shielding layers 7A and 7B and a photoconductive layer 13A, and these layers are laminated between the transparent electrodes 5A and 6A.

The light modulation element 16B has substrates 3B and 4B on which transparent electrodes 5B and 6B are formed, respectively. The light modulation element 16B further has the liquid crystal layer 8C, which reflects reading light 12C, a light shielding layer 7C and a photoconductive layer 13B, and these layers are laminated between the transparent electrodes 5B and 6B. The light modulation elements 16A and 16B may have one common substrate in place of the substrates 4A and 3B.

The liquid crystal layers 8A, 8B and 8C are cholesteric liquid crystal layers which selectively reflect blue (B) light, green (G) light and red (R) light, respectively. By switching a voltage application sub-unit 10, which will be described later, of the writing unit 2, the orientation of each of the liquid crystal layers 8A, 8B and 8C is changed to allow each of these layers to reflect or transmit desired light. Thus, each of blue reading light 12A, green reading light 12B and red reading light 12C is reflected or transmitted.

The relationship between the configurations of the photoconductive layers 13A and 13B and the colors of writing light (exposure light) 15A and writing light (exposure light) 15B to be absorbed by the corresponding photoconductive layer is the same as that in the embodiment shown in FIG. 2. That is, the photoconductive layer 13A absorbs the writing light 15A, or blue (B) light, decreasing the resistance value of the photoconductive layer 13A, but transmits the green (G) reading light 12B and the red (R) reading light 12C. Accordingly, green light and red light do not change the resistance value. The photoconductive layer 13B absorbs the red (R) writing light 15B, lowering the resistance value of the photoconductive layer 13B, but transmits the blue writing light 15B, which, therefore, does not change of the resistance value of the photoconductive layer 13B.

To enable the light shielding layers 7A, 7B and 7C to respectively shield reading light having wavelengths the same as those of light which can be absorbed by the photoconductive layer 13A, and reading light having wavelengths the same as those of light which can be absorbed by the photoconductive layer 13B, the light shielding layer 7B has red color, which absorbs and shields blue (B) light, and the light shielding layer 7C has blue (B) color, which absorbs and shields red (R) light.

Here, since the light shielding layer 7A needs to transmit the green (G) reading light 12B and the red (R) reading light 12C, the light shielding layer 7A may be yellow or transparent, or may be omitted.

The liquid crystal layer 8C can be driven in the same manner as the liquid crystal layer 8B shown in FIG. 2. Hereinafter, driving of the liquid crystal layers 8A and 8B will be more detailed.

The cholesteric liquid crystals of the liquid crystal layers 8A and 8B have different threshold values (lower and higher threshold values) with respect to voltage applied to the whole of the light modulation element 16A. The writing unit 2 has the aforementioned voltage application sub-unit 10, a light irradiation sub-unit 14 which irradiates the light modulation unit 1 with the writing light 15A and the writing light 15B, and a controller 9 which controls the voltage application sub-unit 10 and the light irradiation sub-unit 14. The controller 9 selects a desired bias voltage to be applied between the electrodes 5A and 6A from a bias voltage which is less than the lower threshold value, that which is not less than the lower threshold value but is less than the higher threshold value, and that which is not less than the higher threshold value so as to control the liquid crystal layers 8A and 8B that reflect light and another light each having a different color. The controller 9 then instructs the voltage application sub-unit 10 to impress the selected bias voltage to be applied between the electrodes 5A and 6A.

Specifically, the electrostatic capacitance of each of the liquid crystal layers 8A and 8B depends on the orientation of the liquid crystal contained therein, since the liquid crystal has dielectric constant anisotropy. When the writing unit 2 applies a bias voltage V to the light modulation element 16A, and irradiates the writing light 15A having a desired luminous energy, and a desired voltage VD is thereby applied to the whole of the liquid crystal layers 8A and 8B, partial voltages which are obtained by distributing the voltage VD according to the electrostatic capacitances are applied to the respective liquid crystal layers 8A and 8B, and the orientation of each of the cholesteric liquid crystals of the liquid crystal layers 8A and 8B changes according to the value of the applied partial voltage.

Accordingly, in the light modulation element 16A, the electrooptic responsivenesses of the liquid crystal layers 8A and 8B with respect to the voltage VD applied to the whole of the liquid crystal layers can be appropriately adjusted by controlling the following two factors: the ratio of the partial voltage obtained by distributing the voltage VD and applied to the liquid crystal layer 8A and that applied to the liquid crystal layer 8B (distribution ratio), and electro-optic responsiveness of each of the liquid crystal layers 8A and 8B to voltage actually applied thereto.

Specifically, the former, or the distribution ratio, can be adjusted by appropriately controlling the ratio of the electrostatic capacitance of the liquid crystal layer 8A and that of the liquid crystal layer 8B, as aforementioned. The latter, or the electrooptic responsivenesses of the liquid crystal layers 8A and 8B, can be adjusted by controlling the dielectric anisotropy, the elastic modulus and the spiral pitch of the cholesteric liquid crystals of the liquid crystal layers 8A and 8B, and, when at least one of the liquid crystal layers include a polymer, the degree of an anchoring effect, which is affected by the structure of the polymer and a phase isolation process and which occurs at the interface between the polymer and the liquid crystal.

When, for instance, the writing light 15A and the writing light 15B are blue and red, respectively, and the reading light 12A, the reading light 12B and the reading light 12C are blue, green and red, respectively, and the light shielding layers 7A, 7B and 7C are yellow, red and blue, respectively, in this structure, a color image can be written and displayed in the device without mingling the exposure light and reading light by irradiating color address light.

Specifically, the image display device shown in FIG. 3 is driven as follows. The value of the bias voltage 11A is selected in consideration of the operational threshold voltages of the liquid crystal layers 8A and 8B, and the luminous energy of the writing light 15A is selected in consideration of the light sensitivity of the photoconductive layer 13A. In addition, the value of the bias voltage 11B is selected in consideration of the operational threshold voltage of the liquid crystal layer 8C, and the luminous energy of the writing light 15B is selected in consideration of the light sensitivity of the photoconductive layer 13B. The voltage application sub-unit 10 of the writing unit 2 impresses the bias voltage 11A between the transparent electrodes 5A and 6A and the bias voltage 11B between the transparent electrodes 5B and 6B. At the same time, the light irradiation sub-unit 14 emits the writing light 15A and the writing light 15B on the substrate 4B of the light modulation unit 1. Thereby, the optical states of the liquid crystal layers 8A, 8B and 8C, or more specifically, the reflection state of the liquid crystal layer 8A with respect to the reading light 12A, the reflection state of the liquid crystal layer 8B with respect to the reading light 12B and the reflection state of the liquid crystal layer 8C with respect to the reading light 12C are changed. The controller 9 controls the timing for application of the bias voltage 11A and that for irradiation of the writing light 15A so that these timings at least partially overlap with each other to enable simultaneous applications of bias voltage 11A which has reached a desired voltage value and writing light 15A whose luminous energy has reached a desired level to the optical modulation element 16A. A combination of the desired voltage and the desired (luminous energy) level is so set as to enable actual driving of the light modulation element 16A, which is a light address-type light modulation element. The controller 9 also controls the timing for application of the bias voltage 11B and that for irradiation of the writing light 15B so that these timings at least partially overlap with each other to enable simultaneous applications of bias voltage 11B which has reached a desired voltage value and writing light 15B whose luminous energy has reached a desired level to the optical modulation element 16B. A combination of the desired voltage and the desired (luminous energy) level is so set as to enable actual driving of the light modulation element 16B, which is a light address-type light modulation element.

Thus, even a device having a light modulation element with a structure where plural liquid crystal layers are laminated between a pair of electrodes can provide a stabilized behavior of each liquid crystal layer, if the device includes a light shielding layer which has the aforementioned configuration and characteristics.

### EXPERIMENTAL EXAMPLE

In order to confirm the effect of the light modulation element of the invention, the following experiments are carried out. Specifically, light modulation elements with a light shielding layer and a liquid crystal layer are prepared and subjected to a heating and accelerating test so as to show change of the electric resistance of the liquid crystal contained in the liquid crystal layer. Furthermore, brief comparison of the characteristics of the light modulation elements is carried out.

Preparation of Light Modulation Element

A light modulation element having the same structure as in FIG. 1 is prepared. Specifically, a commercially available PET resin film on one surface of which ITO is formed is used as a transparent substrate 37 (area of 85.5 mm×54 mm). An OPC layer 35 having a three-layered structure of a first charge-generating layer 40, a charge transport layer 39 and a second charge-generating layer 38 is formed on the transparent substrate 37 as follows.

First, an alcohol solution of a polyvinyl butyral resin where a phthalocyanine pigment-type charge-generating material is dispersed is coated on the transparent substrate 37 by a spin coating method to form the first charge-generating layer 40, which has a thickness of 0.1 μm. Then, a chlorobenzene solution of a diamine-type charge transport material and a polycarbonate resin is coated on the first charge-generating layer 40 with an applicator to form the charge transport layer 39, which has a thickness of 3 μm. Finally, the alcohol solution of a polyvinyl butyral resin where a phthalocyanine pigment-type charge-generating material is dispersed is coated on the charge transport layer 39 by a spin coating method to form the second charge-generating layer 38, which has a thickness of 0.1 μm. Thus, the OPC layer 35 is obtained. The OPC layer 35 is sensitive to light within the wavelength region of 600 to 800 nm.

In the next place, 30 parts by mass of a phthalocyanine blue pigment is added to 70 parts by mass of one of partially saponified polyvinyl alcohols shown below, and the resultant mixture is added to water. The resulting admixture is heated and stirred to obtain a polyvinyl alcohol solution where the pigment is dispersed. Thus, aqueous inks for forming a light shielding layer are prepared. Here, the viscosity of each of the aqueous inks depends on the kind of the polyvinyl alcohol contained therein. Therefore, the concentration of the solid matter in each of the aqueous inks is adjusted so that a film obtained by spin coating of the aqueous ink has a constant thickness.

The partially saponified polyvinyl alcohols used have the following characteristics of (1) to (3).

(1) Saponification degree of about 80 mole percent, and polymerization degree of 500 (product manufactured by Kuraray Co., Ltd.),

(2) Saponification degree of about 80 mole percent, and polymerization degree of 1,000 (product manufactured by Kuraray Co., Ltd.) and

(3) Saponification degree of about 80 mole percent, and polymerization degree of 2,400 (product manufactured by Kuraray Co., Ltd.).

For comparison, light shielding layers respectively including completely saponified polyvinyl alcohol (having a saponification degree of about 98 mole percent and a polymerization degree of 1,000, and manufactured by Kuraray Co., Ltd.) and an acrylic resin and formed on the OPC layer 35 are prepared.

Each of the aforementioned aqueous inks is spin-coated on the OPC layer 35 to form a light shielding layer 34 having a thickness of 1.2 μm. The resultant elements are named elements A. The light shielding layers show absorption of an optical density of 2 or more in the wavelength region of 600 to 700 nm and sufficiently high absorption in the whole of the wavelength region of light to which the photoconductive layer 4 is sensitive. Thus, five kinds of elements A are prepared.

In the next place, a commercially available ITO-deposited PET resin film is used as a transparent substrate 31 and an electrode 32, and a gelatin aqueous coating liquid in which a cholesteric liquid crystal emulsion is dispersed is coated on the ITO deposition film to form a liquid crystal layer 33 having a thickness of 10 μm. The resultant element is named element B.

The gelatin aqueous coating liquid in which a cholesteric liquid crystal emulsion is dispersed is obtained as follows. First, a cholesteric liquid crystal having a controlled selective reflection wavelength of 550 nm is stirred to form dispersion particles having a uniform diameter by an SPG film emulsifying method. Thus, an emulsion aqueous solution is prepared. Subsequently, the emulsion aqueous solution is concentrated, and the concentrated liquid is mixed with a gelatin aqueous solution.

Confirmation Test of Variation of Resistance of Liquid Crystal Layer

The cholesteric liquid crystal is directly dripped on each of the five kinds of elements A, and the resultant is placed on a hot plate kept at 80° C. for three hours to accelerate variation of the element over time. After the resultant is cooled down to room temperature, the dripped liquid crystal is suctioned with a syringe and injected into a resistance measurement cell made by the inventors of the invention.

The impedance of the liquid crystal in the resistance measurement cell is measured in the frequency range of 1 Hz to 1 kHz with an impedance analyzer. The measured values are averaged to obtain an average resistance value. Furthermore, the average resistance value of the cholesteric liquid crystal alone (measurement sample 1) is measured in the same manner as the above.

Measurement results are shown in Table 1. In Table 1, measurement samples 2 through 4 are samples related to the invention and measurement samples 5 and 6 are comparative samples.

TABLE 1

| | | PVA Characteristics | | Average |
|---|---|---|---|---|
| | | Saponification | Polymerization | resistance |
| | Content | degree (mole %) | degree | (Ω) |
| Measurement | Liquid crystal alone | — | — | 1.4 × 10⁷ |
| sample 1 | | | | |
| Measurement | Light shielding layer | 80 | 500 | 1.2 × 10⁷ |
| sample 2 | including partially | | | |
| | saponified PVA | | | |
| Measurement | Light shielding layer | 80 | 1000 | 1.1 × 10⁷ |
| sample 3 | including partially | | | |
| | saponified PVA | | | |
| Measurement | Light shielding layer | 80 | 2400 | 1.8 × 10⁶ |
| sample 4 | including partially | | | |
| | saponified PVA | | | |
| Measurement | Light shielding layer | 98 | 1000 | 1.8 × 10⁴ |
| sample 5 | including completely | | | |
| | saponified PVA | | | |
| Measurement | Light shielding layer | — | — | 1.6 × 10⁵ |
| sample 6 | including acrylic resin | | | |

The result of this heating and accelerating test shows that the liquid crystals respectively from the measurement samples 5 and 6 have an average resistance value much lower than that of the liquid crystal itself (measurement sample 1) and has deteriorated characteristics. In contrast, the liquid crystals which were brought into contact with the light shielding layer having a configuration recited in the invention have an average resistance value almost the same as that of the liquid crystal itself, even after the heating and accelerating test.

Evaluation of Light Modulation Element

In the next place, the element B and each of the elements A are laminated with a vacuum laminator to prepare evaluation samples (light modulation elements). After these samples are left under an environment kept at 60° C. for 24 hours, a photomask is brought into contact with each of the light modulation elements, and each of the light modulation elements is exposed to writing light emitted by an LED array, which serves as a light source, and having a wavelength of 630 nm through the photomask at an exposure intensity of 500 μW/cm². Simultaneously, a symmetrical rectangular wave pulse voltage with a frequency of 50 Hz and a crest value of 200 V is applied between the electrodes 32 and 36. Thus, a visible image is recorded in each of the light modulation elements.

As a result, the light modulation elements of the invention including the respective partially saponified polyvinyl alcohols in the light shielding layers show good reflectance of 20%. On the other hand, the light modulation elements respectively including the completely saponified polyvinyl alcohol and the acrylic resin have a reflectance of 15% or less, which is lower than that of each of the light modulation elements of the invention.

What is claimed is:

1. A light modulation element in which a visible image is written by simultaneously conducting irradiation of the light modulation element with exposure light according to image information which corresponds to the visible image and application of a voltage, comprising:
a pair of electrodes to which the voltage is applied;
a photoconductive layer which, when the light modulation element has been irradiated with the exposure light, shows an electric characteristic distribution corresponding to an intensity distribution of the exposure light;
a liquid crystal layer to which a partial voltage derived from the voltage applied to the pair of electrodes and having a distribution corresponding to the electric characteristic distribution of the photoconductive layer is applied to record a visible image having an optical characteristic distribution corresponding to the distribution of the partial voltage; and
a light shielding layer disposed between the photoconductive layer and the liquid crystal layer,
wherein the photoconductive layer, the liquid crystal layer and the light shielding layer are disposed between the electrodes, and the light shielding layer contains a resin comprising partially saponified polyvinyl alcohol.

2. The light modulation element according to claim 1, wherein the partially saponified polyvinyl alcohol has a saponification degree of less than 97 mole percent.

3. The light modulation element according to claim 1, wherein the partially saponified polyvinyl alcohol has a polymerization degree of 300 to 2,000.

4. The light modulation element according to claim 1, wherein the light shielding layer further contains a pigment.

5. The light modulation element according to claim 4, wherein the mass ratio of the pigment to the resin in the light shielding layer is 20/80 to 40/60.

6. The light modulation element according to claim 1, wherein the light shielding layer has a thickness of 0.5 to 3.0 μm.

7. An image display device, comprising:
a light modulation unit comprising a light modulation element in which a visible image is written by simultaneously conducting irradiation of the light modulation element with exposure light according to image information which corresponds to the visible image and application of a voltage; and
a writing unit for writing the visible image in the light modulation unit,
wherein:
the light modulation element comprises a pair of electrodes to which the voltage is applied, a photoconductive layer which, when the light modulation element has been irradiated with the exposure light, shows an electric characteristic distribution corresponding to an intensity distribution of the exposure light, a liquid crystal layer to which a partial voltage derived from the voltage applied to the pair of electrodes and having a distribution corresponding to the electric characteristic distribution of the photoconductive layer is applied to record a visible image having an optical characteristic distribution corresponding to the distribution of the partial voltage, and a light shielding layer disposed between the photoconductive layer and the liquid crystal layer, wherein the photoconductive layer, the liquid crystal layer and the light shielding layer are disposed between the electrodes, and the light shielding layer contains a resin comprising partially saponified polyvinyl alcohol; and
the writing unit comprises a voltage application sub-unit which applies the voltage to the pair of electrodes of the light modulation element, a light irradiation sub-unit which irradiates the light modulation element with the exposure light, and a controller which controls the voltage application sub-unit and the light irradiation sub-unit.

8. The image display device according to claim 7, wherein the partially saponified polyvinyl alcohol has a saponification degree of less than 97 mole percent.

9. The image display device according to claim 7, wherein the partially saponified polyvinyl alcohol has a polymerization degree of 300 to 2,000.

10. The image display device according to claim 7, wherein the light shielding layer further contains a pigment.

11. The image display device according to claim 10, wherein the mass ratio of the pigment to the resin in the light shielding layer is 20/80 to 40/60.

12. The image display device according to claim 7, wherein the light shielding layer has a thickness of 0.5 to 3.0 μm.
